(19) United States
(12) Patent Application Publication
(10) Pub. No.: US 2006/0156328 A1
(43) Pub. Date: Jul. 13, 2006

(54) Method of and system for distributing a content item

(75) Inventors: Minnie Van Der Veen, Eindhoven (NL); Peter Bernhard Kaars, Sunnyvale, CA (US); Antonius Adrianus Cornelis Kalker, Mountain View, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,644

(22) PCT Filed: Jul. 1, 2004
(86) PCT No.: PCT/IB04/51097

§ 371 Date: Jan. 6, 2006

(30) Foreign Application Priority Data
Jul. 10, 2003 (EP) 03102075.3

(51) Int. Cl. H04N 7/16; H04H 9/00; H04N 7/00; H04N 11/00

(52) U.S. Cl. 725/20; 725/135; 725/25; 348/468

(57) ABSTRACT

A method of and system for distributing a content item to a recipient. The content item contains a marker linked uniquely to the recipient. At a first point in time, the marker is inserted in the content item. At a second point in time, an association between the marker and the recipient of the content item is registered. The first point in time lies before a point in time at which the recipient is known. The marker is preferably inserted by means of a watermark. In an embodiment the first point in time lies at a point in time at which processing load is relatively low. Multiple markers can be inserted in a single content item.

The invention relates to a method of distributing a content item to a recipient, which content item contains a marker linked uniquely to the recipient. The invention relates further to a system for distributing a content item to a recipient, which content item contains a marker linked uniquely to the recipient.

A popular way of electronically distributing content such as music, movies and electronic books, is to have a server distribute these content items to a number of recipients. Many servers currently exist on the Internet that distribute compressed audio signals to client computers, for example. The recipient of such a content item may be able to further distribute this content item to other recipients. Usually this occurs without the permission of the publisher of the content item. To prevent or limit such an unauthorized distribution, special measures are needed.

It is known to insert markers in content items which are linked uniquely to the recipient. For example, an identifier for the recipient can be embedded into the content item by means of a watermark. The identifier can be the name of the recipient or a network address of the receiving computer. If the content item is subsequently distributed further in an unauthorized fashion, it can be analyzed to extract the watermark and thereby recover the identifier. This enables the publisher to take appropriate action against the initial recipient of the content item.

Inserting such markers involves computationally expensive processing.

Additionally, the content item may be stored in compressed and/or encrypted fashion on a disc in the server system, which means that the content item needs to be decompressed and/or decrypted, watermarked, and subsequently recompressed and/or re-encrypted. Because of the relatively large computational costs involved, this processing will constrain the maximum distribution capacity, i.e. limit the maximum number of downloads per time window.

Conventional solutions for this problem usually involve adding extra hardware to the server system or introducing multiple distribution points. However, this only reduces the problem to a limited extent. Especially during peak hours, the processing capacity of the server system will be bottleneck in the distribution.

It is an object of the invention to provide a method and a system according to the preamble which reduces the amount of processing needed to uniquely link a content item to a recipient during distribution of this content item to this recipient.

This object is achieved according to the invention in a method comprising at a first point in time, inserting the marker in the content item, at a second point in time, registering an association between the marker and the recipient of the content item, in which the first point in time lies before a point in time at which the recipient is known.

This object is achieved according to the invention in a system for distributing a content item to a recipient, which content item contains a marker linked uniquely to the recipient, comprising marking means for, at a first point in time, inserting a marker in the content item, and associating means for, at a second point in time, registering an association between the marker and the recipient, the first point in time being before the recipient is known.

The marker is preferably inserted by means of a watermark. By separating the computationally expensive act of inserting the marker from the less expensive act of registering the association between the marker and the recipient, it becomes possible to shift the act of inserting the marker to a point in time where this processing will not affect the performance of the distributing server. It is actually the act of registering the association that uniquely links the content item to the recipient, the insertion of the marker can take place at any time. By inserting the marker before the recipient is known, it is achieved that no computationally expensive acts have to be performed when the recipient requests distribution of the content item.

In an embodiment the first point in time lies at a point in time at which processing load is relatively low. Typically, the load on a distributing server system will be lower during the night than during the day. This makes it possible to insert markers into content items at night without imposing too high a load on the distributing server. During peak hours then only the association needs to be registered, which can be done very quickly and without heavy demands on the processing capacity of the server. An advantage now is that the distribution rate of content items at peak hours is now increased.

In an embodiment multiple markers are inserted in the content item. This makes it possible to distribute the content item to multiple recipients by simply registering respective associations between each of those multiple markers and a respective recipient. It is thus no longer necessary to create separate copies or specimens of the content item for each recipient.

In an embodiment the content item is selected based on an analysis of previously distributed content items. In many cases it will be necessary to make a selection of which content items should be marked. Preferably this selection is done based on an analysis of which content items are most popular, in other words which were previously distributed the most. Content items that were not marked at the first point in time will have to be marked upon request by the recipient. By marking in advance the most popular content items, the number of content items that need to be marked during peak hours is reduced.

Further advantageous embodiments are set out in the dependent claims.

These and other aspects of the invention will be apparent from and elucidated with reference to the embodiments shown in the drawing, in which:

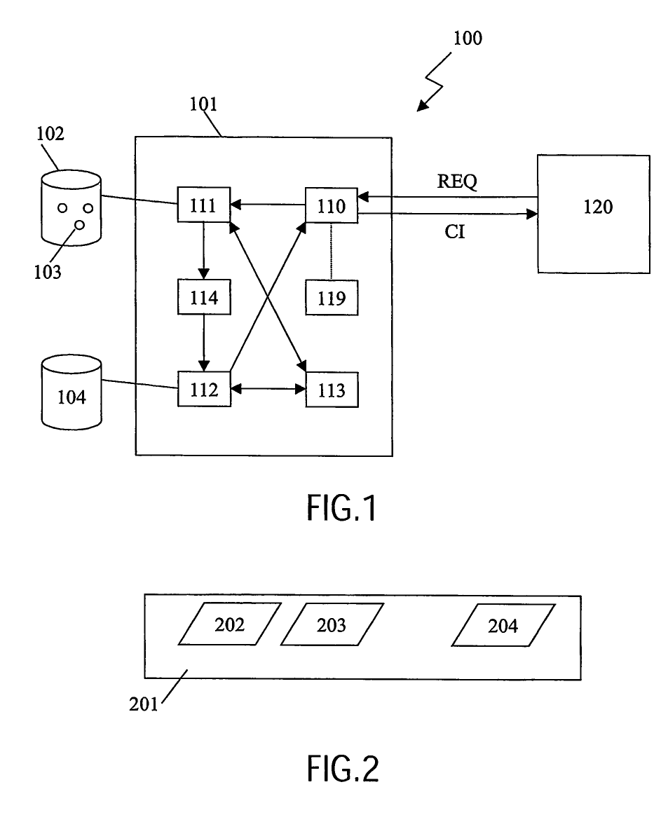

FIG. 1 schematically illustrates an embodiment of the system according to the invention;

FIG. 2 schematically illustrates a first embodiment of markers inserted in content items.

Throughout the figures, same reference numerals indicate similar or corresponding features. Some of the features indicated in the drawings are typically implemented in software, and as such represent software entities, such as software modules or objects.

FIG. 1 schematically illustrates a system 100 comprising a server 101 and a client 120. The server 101 manages a collection of content items for distribution to the client 120. To this end, the server 101 comprises a request handling module 110 that receives a request for a particular content item 103 from the client 120. A database management (DBMS) module 111 retrieves the content item 103 from the database 102 and supplies it to delivery module 112.

In accordance with the present invention, the delivery module 112 checks whether a marker has been inserted in the content item 103. If so, the delivery module 112 registers an association between the marker in the content item 103 and the recipient in a customer database 104. The delivery module 112 then makes the content item 103 available to the client 120, for example by passing it back to the request handling module 110 which can supply it over a network to the client 120.

If there is no marker in the content item 103, the delivery module 112 activates a marking module 113 which in response inserts an appropriate marker in the content item 103. Preferably the marker is inserted as the value of a counter which is embedded in the content item 103 by means of a watermark. Every time the marking module 113 inserts the marker, it increases the value of the counter by one. Of course an infinite number of counting mechanisms exist. Increasing it by one is just one example. As the marker is derived from the present value of the counter, it is now achieved that every content item has a unique marker inserted. It is now also simply possible to register the value of the counter with an identifier for the client 120 in the customer database 104.

Many other options exist to choose suitable markers. For instance, pseudo-randomly chosen numbers could be chosen, or the moment in time at which the marker is to be inserted could be used as a value of the marker.

Requesting the content item 103 and subsequent delivery thereof is, as such, well known in the art. It can be implemented for example by using a web server in the server 101 and a web browser in the client 120.

The content items may be stored in the database 102 in compressed fashion. It will then be necessary to decompress the content items before the marker can be inserted. After inserting the marker, the content item to be distributed must be compressed again. Alternatively, the content items can be stored in the database 102 without any compression. Still, it will be desirable to compress the content items before distribution so as to minimize transmission time. A compression module 114 is provided to this end.

An alternative is to embed the watermark in the compressed domain. This way the content does not have to be decompressed first. Ways to embed a watermark in the compressed domain are discussed in European patent application serial number 03101546.4 (attorney docket PHNL030600) and European patent application serial number . . . (attorney docket PHNL030720).

To facilitate secure delivery, the content item can be encrypted before distribution to the client 120. Many protocols exist for using encryption to securely transfer a content item from a server to a client, and so this document will not elaborate on this aspect further. The content item 103 may be stored on the server in encrypted fashion using a key specific to the content item 103. This key can then be encrypted using a public key of the client, which means that the content item 103 does not have to be encrypted as a whole for the client.

If the content item 103 is stored encrypted on the server, then it usually must be decrypted before the marker can be inserted. It then most likely will have to be encrypted again. Both the step of decrypting and of encrypting again will introduce significant additional processing requirements.

A load estimating module 119 is provided that monitors at periodic intervals the processing load on the server. This can be measured in many different ways. For example, the module 119 can measure the percentage of time at which the central processing unit of the server 101 is in an idle state, or the number of requests per time unit (e.g. per hour). Based on the periodically collected information, the load estimating module 119 can determine points in time at which the processing load on the server 101 is relatively low, for example because the number of requests at those points is on average the lowest compared to other points of time.

Once the load estimating module 119 has determined that at a particular point in time the processing load on the server is relatively low, it activates at that point in time the marking module 113. This causes the marking module 113 to request one or more content items from the DBMS module 111 and to insert markers in the requested content items. The marked contents items are subsequently stored again in the database 102 by the DBMS module 111. Because the processing load on the server 101 is relatively low at this point in time, the act of inserting markers in these content items will not affect the handling of any requests that may be submitted at that time by the client 120.

FIG. 2 schematically illustrates a first embodiment of content items in which markers are inserted. In this embodiment, multiple markers 211, 212, 213 are inserted in the content item 201. These could be embedded as separate watermarks, or as a single watermark containing the concatenation of the respective markers. In this embodiment, the delivery module 112 checks for the presence of markers in the content item 201 and detects the markers 211, 212, 213. It now also needs to check in the customer database 104 whether any of these markers are already associated with particular recipients. If for example the marker 213 is not yet associated with any recipients in the database 104, the delivery module 112 now registers an association between the marker 213 and the client 120 in the customer database 104.

If all markers are already associated with particular recipients, the delivery module 1 12 now either activates the marking module 1 13 or requests another copy of the content item 201 from the DBMS module 11 1 which does not have the markers 211, 212, 213.

The DBMS module 111 may keep track of how many times each particular content item is requested from the database 102. Based on an analysis of these figures, it is possible to determine which content items were requested the most. The DBMS module 11 1 may make this information available to the marking module 1 13. This allows the marking module 113 to process, at times that load is minimal, some of these content items and mark them.

In the embodiment of FIG. 2, it also enables the marking module 113 to determine the number of multiple markers to be inserted based on this analysis. For example, if it turns out that every day a particular content item is requested by 10 different people, the marking module 1 13 should insert 10 different markers.

After a content item has been distributed to the client 120, the specimen containing the marker that has now been uniquely linked to the client 120 now needs to be deleted from the database 102. This way the next client requesting that particular content item will get a specimen with a different marker that is uniquely linked to him. In the embodiment of FIG. 2, this only needs to happen if all the markers embedded in the content item 201 have been associated with respective recipients.

The marking module 113 may request a content item from the DBMS module 111 and create multiple specimens of this content item, each with a different marker. The number of different content items marked in this way can also be based on the popularity figures obtained by the DBMS module 111. This way a sufficient number of already marked content items is available for distribution.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the system claim enumerating several means, several of these means can be embodied by one and the same item of hardware. The mere fact that certain measures are recited in mutually different dependent claims does not indicate that a combination of these measures cannot be used to advantage.

1. A method of distributing a content item to a recipient, which content item contains a marker linked uniquely to the recipient, comprising
at a first point in time, inserting the marker in the content item,
at a second point in time, registering an association between the marker and the recipient of the content item,
in which the first point in time lies before a point in time at which the recipient is known.

2. The method of claim 1, in which the marker is inserted in the content item by means of a watermark.

3. The method of claim 1, in which the association between the marker and the recipient is registered by storing an information element comprising the marker and an identifier for the recipient in a database.

4. The method of claim 1, in which the marker is derived from a value of a counter that is increased every time a marker is inserted in a content item.

5. The method of claim 1, in which multiple markers are inserted in the content item.

6. The method of claim 5, in which a respective association between each respective marker and a respective recipient is registered.

7. The method of claim 5, in which the number of multiple markers is 25 determined based on an analysis of previously distributed content items.

8. The method of claim 1, comprising selecting the content item in which the marker is to be inserted based on an analysis of previously distributed content items.

9. The method of claim 1, comprising inserting the respective markers in respective specimens of the content item, and distributing said respective specimens to respective recipients, and registering a respective association between the respective markers and the respective recipients.

10. A system for distributing a content item to a recipient, which content item contains a marker linked uniquely to the recipient, comprising marking means for, at a first point in time, inserting a marker in the content item, and associating means for, at a second point in time, registering an association between the marker and the recipient, the first point in time being before the recipient is known.

11. The system of claim 10, comprising load estimation means for selecting the first point in time as a point in time at which processing load of the system is relatively low.

12. A computer program product arranged for causing a processor to execute the method of claim 1.
